(19) United States
(12) Patent Application Publication
(10) Pub. No.: US 2025/0149816 A1
(43) Pub. Date: May 8, 2025

(54) PCI EXPRESS ADD-IN CARD ADAPTER CABLE FOR SUPPORTING MULTI-PORT MEMORY SYSTEM

(71) Applicant: Yangtze Memory Technologies Co., Ltd., Wuhan (CN)

(72) Inventor: Guangjun LYU, Wuhan (CN)

(73) Assignee: Yangtze Memory Technologies Co., Ltd., Wuhan (CN)

(21) Appl. No.: 18/519,729

(22) Filed: Nov. 27, 2023

(30) Foreign Application Priority Data
Nov. 6, 2023 (CN) 202311473226.9

(51) Int. Cl. H01R 13/02; G06F 13/42; H01R 13/6471

(52) U.S. Cl. CPC H01R 13/025; G06F 13/4291; H01R 13/6471; G06F 2213/0026

(57) ABSTRACT

An adapter cable can include a receptacle connector including contact pins as defined for a peripheral component interconnect express (PCIe) connector; edge connectors having edge pins as defined for a PCIe add-in card (AIC); and connections connecting the receptacle connector to the edge connectors, each connection connecting one of the contact pins to one of the edge pins.

### INCORPORATION BY REFERENCE

The present application claims the benefit of the Chinese Patent Application No. 202311473226.9, filed Nov. 6, 2023, which is incorporated by reference herein in its entirety.

### TECHNICAL FIELD

The present application is related to an adapter cable for peripheral component interconnect express (PCIe) applications.

### BACKGROUND

Peripheral component interconnect express (PCIe) is a high-speed serial computer expansion bus standard. PCIe provides a common motherboard interface for graphics cards, sound cards, hard disk drive host adapters, solid-state drives, Wi-Fi, and Ethernet hardware connections in computer systems. The non-volatile memory express (NVMe) protocol can use PCIe as a transport in a storage system.

### SUMMARY

Aspects of the disclosure provide an adapter cable. The adapter cable can include a receptacle connector including contact pins as defined for a peripheral component interconnect express (PCIe) connector; edge connectors having edge pins as defined for a PCIe add-in card (AIC); and connections connecting the receptacle connector to the edge connectors, each connection connecting one of the contact pins to one of the edge pins.

Aspects of the disclosure provide an adapter cable for connecting a PCIe AIC to PCIe connectors. The adapter cable can include a receptacle connector for receiving the PCIe AIC, the receptacle connector including contact pins as defined for a PCIe connector; edge connectors for being mounted to the PCIe connectors, respectively, one of the edge connectors having edge pins as defined for a PCIe AIC; and connections connecting the receptacle connector to the edge connectors, each connection connecting one of the contact pins to one of the edge pins.

In an embodiment, first contact pins of the receptacle connector corresponding to at least one PCIe lane are connected to first edge pins of a first edge connector of the edge connectors, via first connections of the connections. Second contact pins of the receptacle connector, different from the first contact pins, corresponding to another at least one PCIe lane are connected to second edge pins of a second edge connector of the edge connectors. For one of the edge connectors, a third contact pin of the receptacle connector is connected to a third edge pin of the respective edge connector, via one of the connections, the third edge pin corresponding to a reset signal as defined in PCIe. For one of the edge connectors, a pair of fourth contact pins of the receptacle connector are connected to a pair of fourth edge pins of the respective edge connector, via ones of the connections, the pair of fourth pins corresponding to a pair of reference clock signals as defined in PCIe.

In an embodiment, the receptacle connector is a ×8 PCIe connector having 49 pins numbered from 1 to 49 on each of side A and side B, and one of the first edge connector and the second edge connector is a ×4 PCIe connector having 32 pins numbered from 1 to 32 on each of side A and side B; the first contact pins are pins 14, 15, 19, and 20 of side B and pins 16, 17, 21, and 22 of side A of the receptacle connector that are connected to the first edge pins that are pins 14, 15, 19, and 20 of side B and pins 16, 17, 21, and 22 of side A of the first edge connector; the second contact pins are pins 23, 24, 27, and 28 of side B and pins 25, 26, 29, and 30 of side A of the receptacle connector that are connected to the second edge pins that are pins 14, 15, 19, and 20 of side B and pins 16, 17, 21, and 22 of side A of the second edge connector; for the first edge connector, pin 11 of side A of the receptacle connector corresponding to a first reset signal as defined in PCIe is connected to pin 11 of side A of the first edge connector; for the second edge connector, pin 32 of side A of the receptacle connector corresponding to a reserved pin as defined in PCIe is connected to pin 11 of side A of the second edge connector; for the first edge connector, the pins 13 and 14 of side A of the receptacle connector corresponding to a pair of reference clock signals as defined in PCIe are connected to the pins 13 and 14 of the first edge connector; and for the second edge connector, the pins 35 and 36 of side A of the receptacle connector corresponding to a PCIe lane as defined in PCIe are connected to the pins 13 and 14 of the second edge connector.

In an embodiment, the receptacle connector is a ×8 PCIe connector having 49 pins numbered from 1 to 49 on each of side A and side B, and one of the first edge connector and the second edge connector is a ×4 PCIe connector having 32 pins numbered from 1 to 32 on each of side A and side B; and a reserved pin of side A of the receptacle connector as defined in PCIe is connected to pin 11 of side A of the second edge connector corresponding to a reset signal as defined in PCIe.

In an embodiment, the receptacle connector is a ×8 PCIe connector having 49 pins numbered from 1 to 49 on each of side A and side B, and one of the first edge connector and the second edge connector is a ×4 PCIe connector having 32 pins numbered from 1 to 32 on each of side A and side B; and a pin of side A of the receptacle connector corresponding to a PCIe lane as defined in PCIe is connected to pin 11 of side A of the second edge connector corresponding to a reset signal as defined in PCIe.

In an embodiment, the receptacle connector is a ×8 PCIe connector having 49 pins numbered from 1 to 49 on each of side A and side B, and one the first edge connector and the second edge connector is a ×4 PCIe connector having 32 pins numbered from 1 to 32 on each of side A and side B; and two contact pins of the receptacle connector corresponding to signals of one or more PCIe lanes are connected to the pins 13 and 14 of the second edge connector corresponding to a pair of clock reference signals as defined in PCIe.

In an embodiment, a number of the contact pins in the receptacle connector is less than a number of contact pins defined in the PCIe connector. In an embodiment, a number of the edge pins in the respective edge connector is less than a number of edge pins defined in the respective PCIe AIC.

In an embodiment, the receptacle connector is one of a ×4 PCIe connector, a ×8 PCIe connector, and a ×16 PCIe connector, and one of the edge connectors is one of a ×1 PCIe connector, a ×4 PCIe connector, a ×8 PCIe connector, and a ×16 PCIe connector. In some embodiments, a total number of the pins of one of the edge connectors is smaller than a total number of the pins of the receptacle connector. In an embodiment, a number of the edge connectors are one of 2, 4, and 8.

Aspects of the disclosure provide a storage system. The storage system can include a PCIe AIC containing a multi-port memory system supporting a multi-port function that enables simultaneous access by computer systems to a same namespace of the multi-port memory system; the computer systems containing PCIe connectors, respectively; and an adapter cable connecting the PCIe AIC to the PCIe connectors of the computer systems. The adapter cable includes a receptacle connector for receiving the PCIe AIC, the receptacle connector including contact pins as defined for a PCIe connector; edge connectors for being mounted to the PCIe connectors, respectively, one of the edge connectors having edge pins as defined for a PCIe AIC; and connections connecting the receptacle connector to the edge connectors, each connection connecting one of the contact pins to one of the edge pins.

In an embodiment, the multi-port memory system is a PCIe-based solid-state drive (SSD) containing a memory controller implementing a non-volatile memory express (NVMe) dual-port function.

Aspects of the disclosure provide a method for setting up a storage system. The method can include connecting a PCIe AIC to PCIe connectors distributed on at least two system boards of computer systems by employing an adapter cable. The PCIe AIC contains a multi-port memory system supporting a multi-port function that enables simultaneous access by the computer systems to a same namespace of the multi-port memory system. The adapter cable can include a receptacle connector for receiving the PCIe AIC, the receptacle connector including contact pins as defined for a PCIe connector; edge connectors for being mounted to the PCIe connectors, respectively, one of the edge connectors having edge pins as defined for a PCIe AIC; and connections connecting the receptacle connector to the edge connectors, each connection connecting one of the contact pins to one of the edge pins.

### BRIEF DESCRIPTION OF THE DRAWINGS

Aspects of the present disclosure can be understood from the following detailed description when read with the accompanying figures. It is noted that, in accordance with the standard practice in the industry, various features are not drawn to scale. In fact, the dimensions of the various features may be increased or reduced for clarity of discussion.

FIG. 1 shows a testing system 100 according to an embodiment of the disclosure.

FIGS. 2A-2D show the pinout for the ×1, ×4, ×8, and ×16 peripheral component interconnect express (PCIe) connectors as defined in the PCIe standards in a table 200.

FIGS. 3A-3B show table 300 of the pinout of the PCIe receptacle connector 131 (CN1) of the PCIe add-in card (AIC) adapter cable 130 in FIG. 1.

FIG. 4 shows table 400 of the pinout of the PCIe edge connector 132 (CN2) of the PCIe add-in card (AIC) adapter cable 130 in FIG. 1.

FIG. 5 shows tables 500 of the pinout of the PCIe edge connector 133 (CN3) of the PCIe add-in card (AIC) adapter cable 130 in FIG. 1.

FIG. 6 shows a method 600 of setting up a storage system using the PCIe AIC adapter cable disclosed herein according to an embodiment of the disclosure.

### DETAILED DESCRIPTION OF EMBODIMENTS

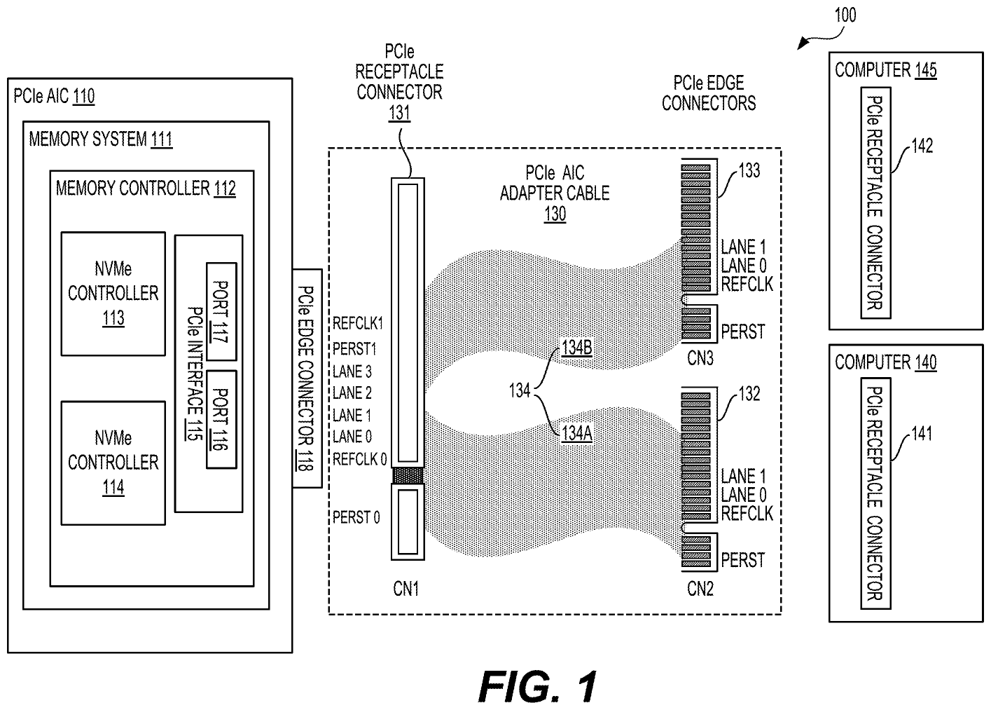

FIG. 1 shows a testing system 100 according to an embodiment of the disclosure. The testing system 100 can be configured to perform testing for a memory system (e.g., solid-state drive (SSD)) dual-port function. The testing system 100 can include a peripheral component interconnect express (PCIe) add-in card (AIC) 110, two computers 140 and 145, and a specifically designed PCIe AIC adapter cable.

A memory system 111 can be implemented on the PCIe AIC 110. The memory system 111 can include a memory controller 112 and one or more memory devices (not shown), such as NAND flash memory devices. Accordingly, the memory system 111 can be an SSD whose operations are controlled by the memory controller 112. In the FIG. 1 example, the memory controller 112 employs a non-volatile memory express (NVMe) protocol to implement a dual-port function. For example, the memory controller 112 can be configured to establish two NVMe controllers 113-114 to realize the dual-port function. To support the NVMe dual-port function, a PCIe interface 115 of the memory controller 112 can be configured to operate as two independent ports 116-117. The two independent ports 116-117 can provide two independent PCIe links. The two independent PCIe links serve as two separate transports for accessing the two NVMe controllers 113-114.

In the testing settings of FIG. 1, the PCIe AIC 110 serves as an evaluation board (EVB) for testing various functions of the NVMe SSD controller 112. The PCIe AIC 110 is configured with a PCIe edge connector 118. Typically, it is desirable to configure a memory controller EVB with a PCIe AIC interface, because the PCIe AIC interface is ubiquitous, and PCIe AIC-based testing environment is easy to establish. For testing the single-port function of NVMe over PCIe transport, the PCIe AIC interface can be sufficient. For example, the NVMe SSD PCIe AIC can be directly inserted into a PCIe receptacle connector on a system board of a host computer. However, the existing PCIe AIC interface is unable to support the testing of the dual-port function of NVMe over PCIe transport. For example, the signals generated from the PCIe interface 115, which enables a dual-port PCIe function, cannot be transmitted to the two computers 140 and 145 via any existing PCIe AIC connectors (e.g., PCIe receptacle connector or PCIe edge connector).

One solution for the above problem is to use U.2 or U.3 interface. For example, the memory controller EVB interface can be changed from the PCIe AIC interface to U.2 or U.3 interface. The modified EVB is then verified with customized equipment, such as a U.2/U.3-based test platform.

The present disclosure provides an alternative solution. The specially configured PCIe AIC adapter cable 130 is used to connect the PCIe AIC 110 to the two computers 140-145 to support the dual-port function testing.

The PCIe AIC adapter cable 130 can include a PCIe receptacle connector 131, a first PCIe edge connector 132, and a second PCIe edge connector 133. The three connectors can be denoted by CN1, CN2, and CN3, respectively, where “CN” stands for “connector”. The receptacle connector 131 is electrically coupled to the two edge connectors 132-133 via a conductive cable 134 (providing electrical connections 134). The conductive cable 134 can include two branches 134A and 134B. A first portion of pins of CN1 131 are connected to pins of CN2 132 via the branch 134A. A second portion of pins of CN1 131 are connected to pins of CN3 133 via the branch 134B. The two portions of pins may overlap. The conductive cable 134 can take various suitable forms. For example, the conductive cable 134 can be a ribbon cable having two branches.

In the FIG. 1 example, CN1 131 can be a PCIe ×8 receptacle connector as defined in PCIe standards. Accordingly, CN1 131 can support 8 PCIe lanes as defined in PCIe standards. CN2 and CN3 can each be a PCIe ×4 edge connector as defined in PCIe standards. Accordingly, CN2 or CN3 can each support 4 PCIe lanes as defined in PCIe standards. Examples of the PCIe standards can include PCI Express Base Specification, Revision 4.0, 5.0, and 6.0, and PCI Express Card Electromechanical Specification Revision 3.0, 4.0, and 5.0. Those PCIe standards are developed and maintained by Peripheral Component Interconnect Special Interest Group (PCI-SIG). In the PCIe standards, the PCIe receptacle connector as referred to in the present disclosure is called a PCIe connector. The PCIe edge connector as referred to in the present disclosure corresponds to a set of edge-fingers (golden-fingers) of an PCIe AIC as defined in the PCIe standards.

As shown, the PCIe AIC adapter cable 130 is configured to support the transmission of ×4 signals (signals of 4 PCIe lanes) between CN1 131 on one side and CN2 132 and CN3 133 on the other side. Specifically, the pins (contact pins) of Lane 0, Lane 1, RefClk0 (reference clock signal 0), and PERST0 (reset signal 0) at CN1 131 are connected to the pins (edge pins) of Lane 0, Lane 1, RefClk (reference clock signal), and PERST (reset signal) at CN2 132. The pins (contact pins) of Lane 2, Lane 3, RefClk1 (reference clock signal 1), and PERST1 (reset signal 1) at CN1 131 are connected to the pins (edge pins) of Lane 0, Lane 1, RefClk, and PERST at CN3 133.

The testing system 100 is set up to be a high-availability storage system. The PCIe Edge connector 118 of the PCIe AIC 110 can be inserted into the PCIe receptacle connector 131 of the PCIe AIC adapter cable 130. The two computers 140 and 145 can each be configured with a PCIe receptacle connector 141 and 142, respectively. The PCIe edge connectors 132-133 of the PCIe AIC adapter cable 130 can be inserted into the PCIe receptacle connectors 141-142, respectively. The two computers 140 and 145 can be referred to as host computers or hosts.

During the operation, two independent PCIe links can be established: a first PCIe link between the PCIe interface 115 and a PCIe root complex of the computer 140, and a second PCIe link between the PCIe interface 115 and a PCIe root complex of the computer 145. The first PCIe link can pass the port 116, the PCIe edge connector 118, the PCIe receptacle connector 131, the cable branch 134A, the CN2 132, and the PCIe receptacle connector 141. The second PCIe link can pass the port 117, the PCIe edge connector 118, the PCIe receptacle connector 131, the cable branch 134B, the CN3 133, and the PCIe receptacle connector 142. The computer 140 (host computer 140) can communicate with the NVMe controller 114 via the first PCIe link. The computer 145 (host computer 145) can communicate with the NVMe controller 113 via the second PCIe link.

In an embodiment, the NVMe controller 113-114 can share a same namespace (a same set of memory devices or memory units). The two host computers 140 and 145 may simultaneously access the same namespace for read or write operations. Under such a dual-port configuration, if one of the two PCIe links fails or one of the two hosts 140 and 145 fails, at least one of the two hosts 140 and 145 can still access the shared namespace, providing a high availability. In an example, the PCIe AIC adapter cable 130 can at least support the fifth generation of PCIe transfer rate, such as 32.0 GT/s (giga transfers per second) per lane in each direction.

Compared with the U.2 and U.3-based solutions, the PCIe AIC-based solution employing the PCIe AIC adapter cable 130 has several advantages. First, the PCIe dual-port function can be verified using the AIC interface, without the limitations of the U.2/U.3 interface and customized verification equipment. Second, the adapter cable 130 is cheap, the verification process can be performed using common motherboards, and customized U.2/U.3 test equipment is not required, significantly reducing the costs. Third, the testing system can be easily set up at a user's workstation. Working with a bulky server rack of U.2/U.3 interface can be avoided. Fourth, the EVB maintains the AIC interface, which facilitates PCIe CTS (compliance test specification) conformance testing.

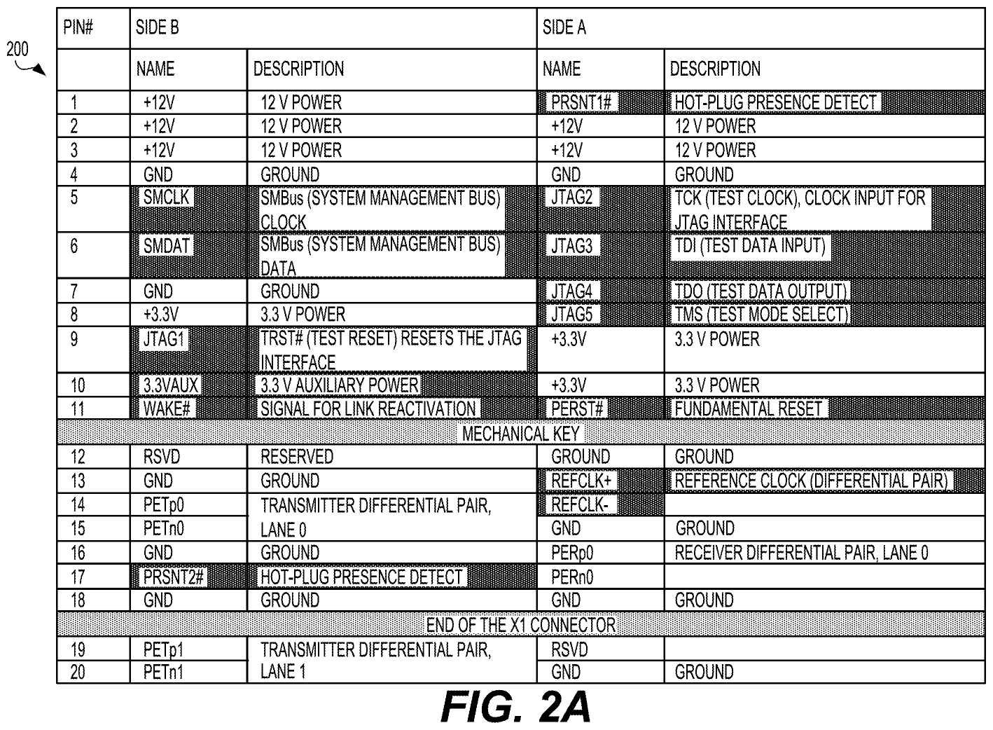

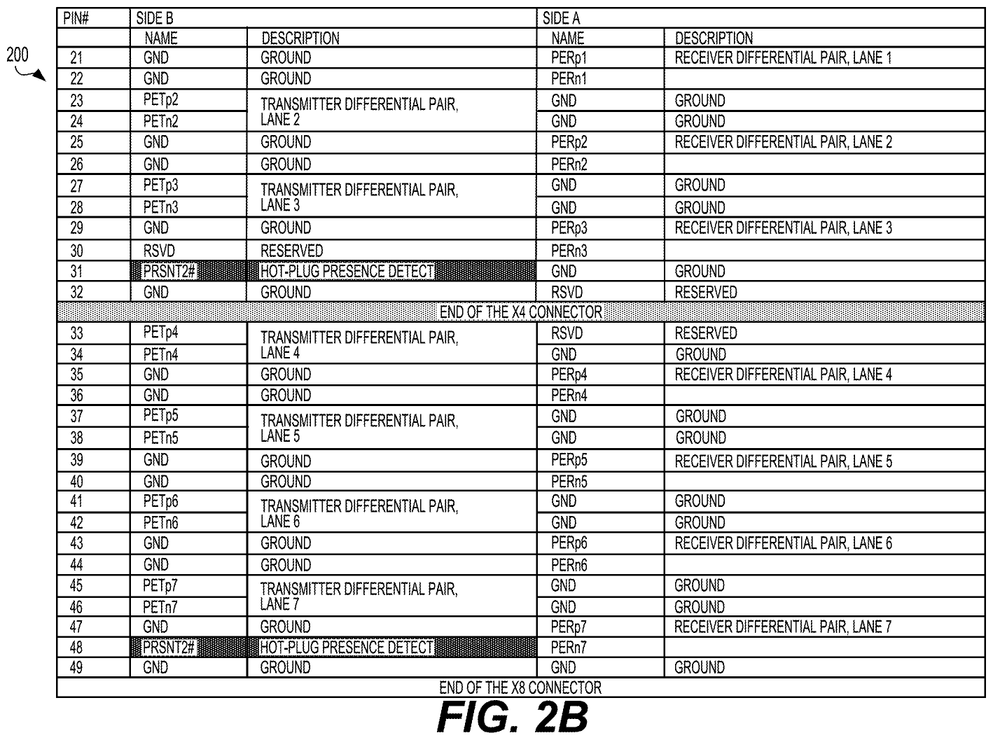

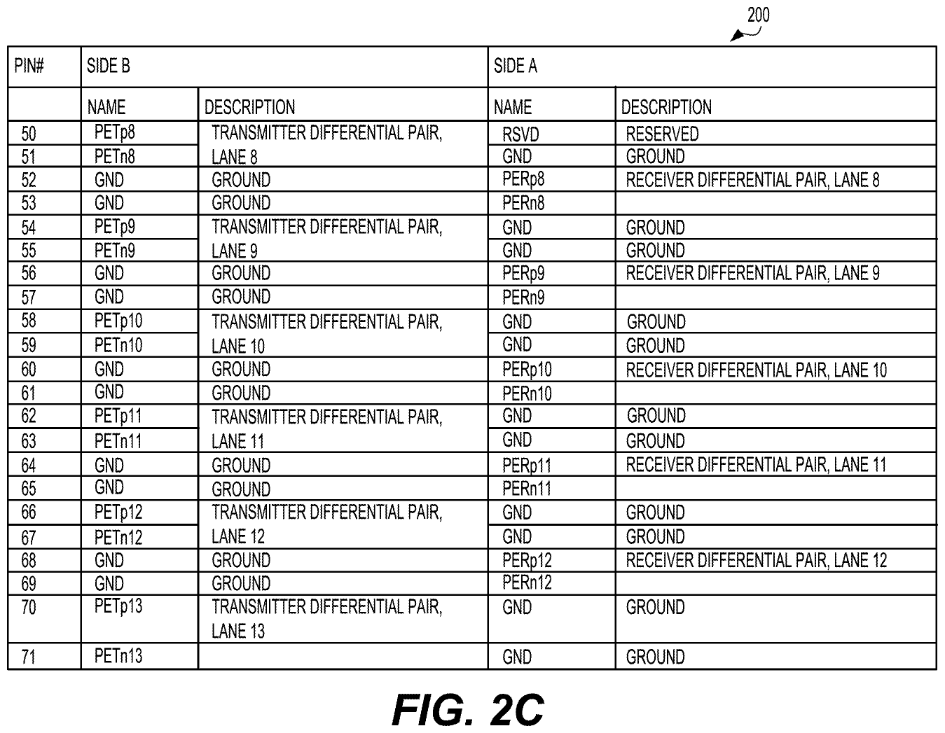

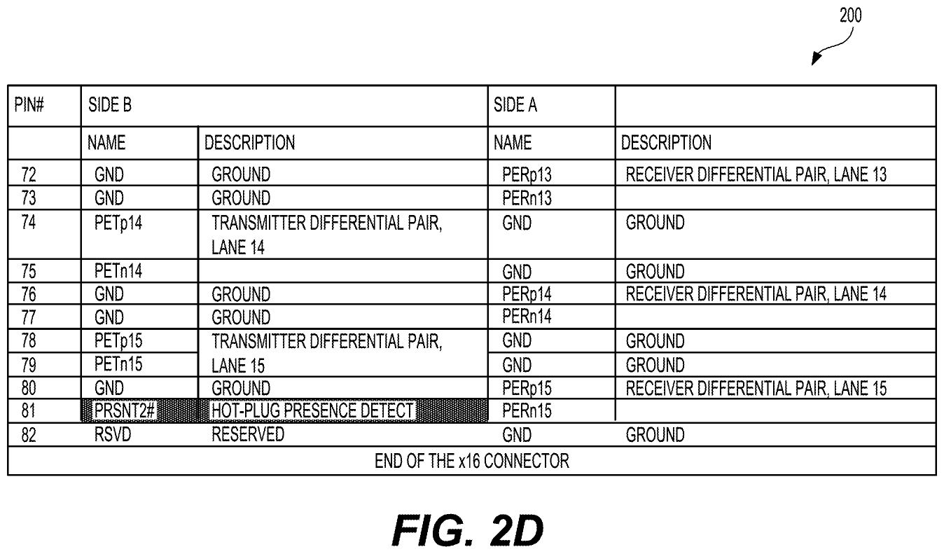

FIGS. 2A-2D show the pinout for the ×1, ×4, ×8, and ×16 PCIe connectors as defined in the PCIe standards in a table 200. The table 200 has 5 columns. The first column shows pin numbers for a PCIe connector's pins in both Side A and Side B. The second column shows the names of signals of Side B associated with the respective pins of Side B. The third column shows brief descriptions of each signal of Side B. The fourth column shows the names of signals of Side A associated with the respective pins of Side A. The fifth column shows brief descriptions of each signal of Side A.

The signals for the listed pins include two types of signals: the PCIe signals and the auxiliary signals. The signal names and descriptions of the auxiliary signals are identified in the shaded areas. These auxiliary signals are used to facilitate the interface between a system board and an add-in card.

The listed pins are numbered from 1 to 82 for each of side A and Side B of a PCIe connector. The PCI Express interface pins PETpx, PETnx, PERpx, and PERnx are named with the following convention: “PE” stands for PCI Express high speed, “T” for Transmitter, “R” for Receiver, “p” for positive (+), and “n” for negative (−). By default, PETpx and PETnx pins (the Transmitter differential pair of the connector) can be connected to the PCI Express Transmitter differential pair on the system board, and to the PCI Express Receiver differential pair on the add-in card. By default, PERpx and PERnx pins (the Receiver differential pair of the connector) can be connected to the PCI Express Receiver differential pair on the system board, and to the PCI Express Transmitter differential pair on the add-in card.

Also, the connectors and the add-in cards are keyed (at the position of the mechanical key between pins 11 and 12) such that smaller add-in cards can be put in larger connectors. For example, a ×1 card can be inserted into the ×4, ×8, and ×16 connectors. This is referred to as up-plugging. Adjacent differential pairs are separated by two ground pins to manage the connector crosstalk. Power pins (+3.3V, +3.3Vaux, and +12V) are defined.

The auxiliary signals are provided on the PCIe connector to assist with certain system-level functionality. These signals may not be used for data transmission in the PCIe architecture. The auxiliary signals can include differential reference clock signal REFCLK−/REFCLK+, reset signal PERST#, wake-up signal WAKE#, system management bus (SMBus) interface clock signal SMBCLK, SMBus interface address/data signal, JTAG signals (TRST#, TCLK, TDI, TDO, and TMS), AIC presence detect signals PRSNT1# and PRSNT2#, +3.3Vaux power rail signal, and the like. The PCIe AIC can use the reference clock on the PCIe connector. When PERST# is active, all PCIe functions can be held in reset.

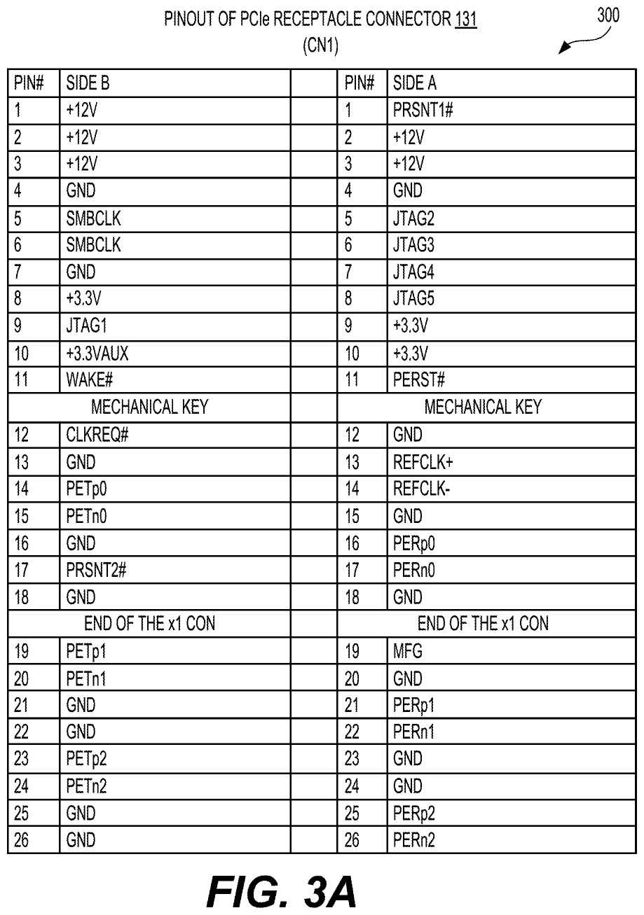

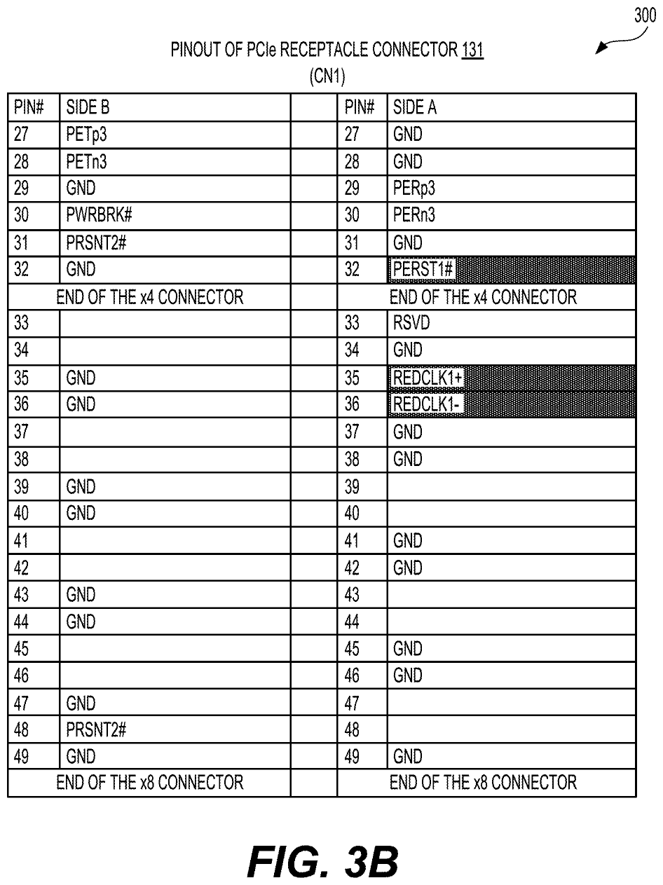

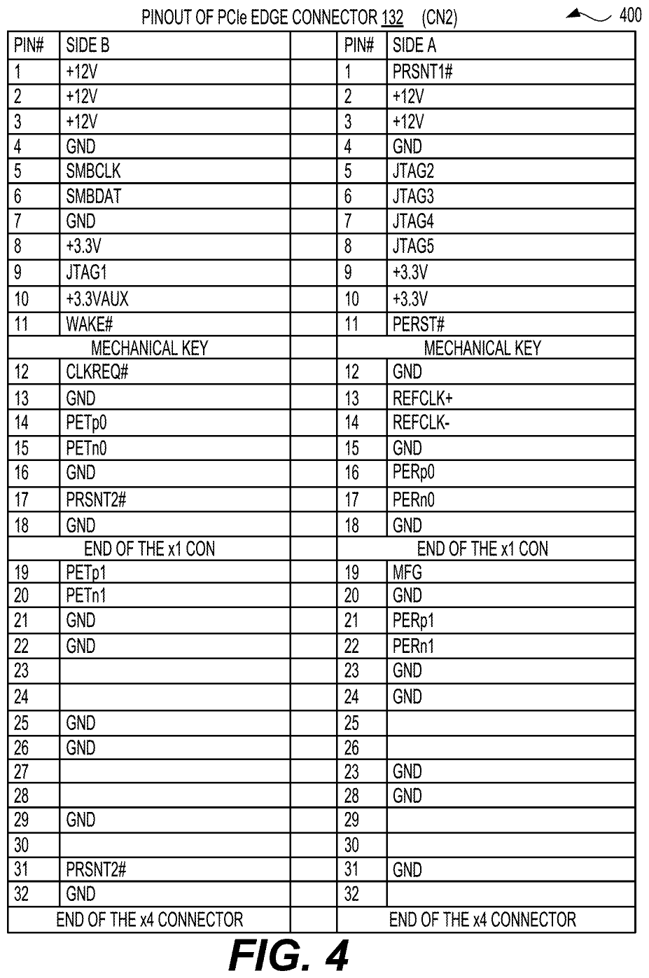

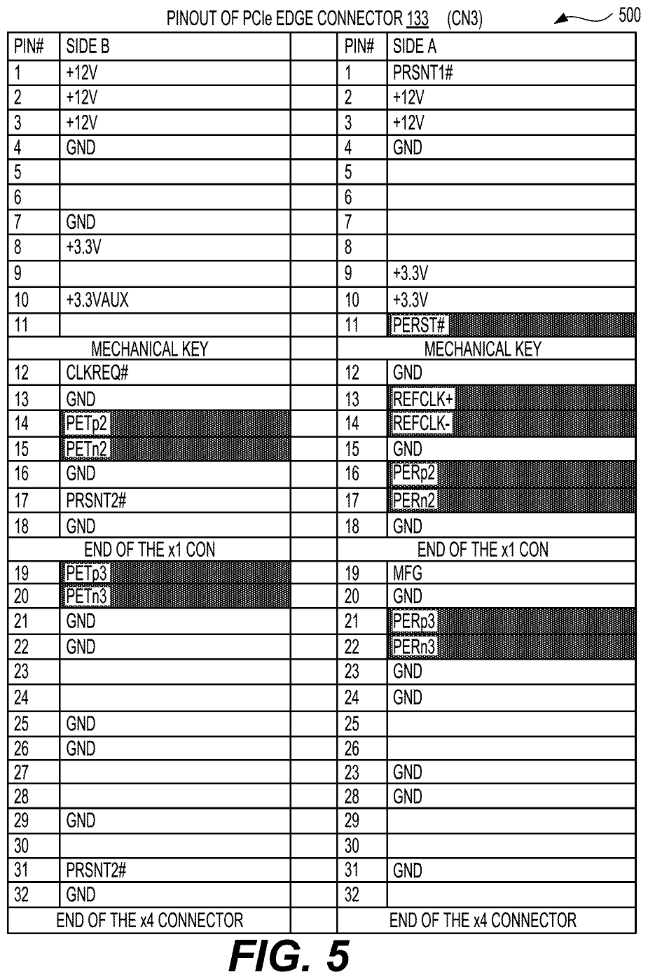

FIGS. 3A/3B/4/5 show tables 300-500 of the pinout of the PCIe receptacle connector 131 (CN1), the PCIe edge connector 132 (CN2), and the PCIe edge connector 133 (CN3) of the PCIe AIC adapter cable 130 in FIG. 1. In each table from 300 to 500, the first column shows the pin numbers of Side B, the second column shows signal names of Side B, the third column is blank, the fourth column shows the pin numbers of Side A, and the fifth column shows signal names of Side A.

CN1 131 physically has a ×8 link width and has the number of pins enough for supporting 8 lanes. CN2 132 and CN3 132 each physically have a ×4 link width and can support 4 lanes. However, in the example of FIG. 1 or FIGS. 3A/3B/4/5, not all pins in each of the CN1 131, CN2 132, or CN3 133 are used. As shown in FIGS. 3A/3B/4/5, for the pins without a signal name present, there will be no signals passing the pins. For example, among many unused pins, pins 33-34 of Side B in table 300 and pins 29-30 of side A in table 400 are not used and are not associated with signals.

The signals of the used pins in the tables 300-500 can be separated into two groups. The first group includes signals similar to the signals defined in the table 200, with respect to the respective pin numbers. The second group includes signals that are defined differently, with respect to the respective pin numbers, than the signals defined in the table 200. These differently defined signals are identified in the shaded areas in the tables 300 and 500.

Specifically, for the pinout of ×8 CN1 131 in table 300, by comparing with the signals of ×8 connector shown in FIGS. 2A-2D, it can be seen that, except the pin 32 (PERST#), 35 (REFCLK1+), and 36 (REFCLK1−) of Side A, other used pins, all or partially, can be associated with signals similar to the signals as indicated in the PCIe standards. The pin 32 of Side A is reserved in table 200, and now is used for a second reset signal PERST1# in table 300. Pin 11 of Side A in table 300 provides the first reset signal PERST#. Pins 35 and 36 of Side A are used for signals of receiver differential pair of lane 4 in table 200, and now are used for a second pair of reference clock signals REFCLK1+/−. Pins 13 and 14 of Side A in table 300 provide the first pair of clock signals REFCLK+/−.

For the pinout of the ×4 CN2 132 in table 400, by comparing with the signals of ×4 connector shown in FIGS. 2A-2D, it can be seen that the used pins, all or partially, can be associated with signals similar to the signals indicated in the PCIe standards. In configuring the PCIe AIC adapter cable 130, the used pins in table 400 can be connected with the respective used pins in table 300 based on the pin numbers. For example, a pair of used pins in tables 400 and 300 having the same pin number can be connected by an electrical connection of the cable 134.

For the pinout of ×4 CN3 133 in table 500, the used pins 14-15 and 19-20 of Side B and the used pins 11, 13-14, 16-17, and 21-22 of Side A have signals belonging to the second group of signals. Those pins are associated with signals different from the signals as defined in the PCIe standards. The pins 14-15 of Side B and the pins 16-17 of Side A are used for PETp0, PETn0, PERp0, and PERn0 (which are signals of lane 0) in table 200, and now are used for PETp2, PETn2, PERp2, and PERn2 (which are signals of lane 2). Accordingly, in the PCIe AIC adapter cable 130, the pins 14-15 of Side B and the pins 16-17 of Side A of CN3 can be connected to the pins 23-24 of Side B and 25-26 of Side A of CN1, respectively, to facilitate the transmission of lane 2 signals. Similarly, in the PCIe AIC adapter cable 130, the pins 19-20 of Side B and the pins 21-22 of Side A of CN3 can be connected to the pins 27-28 of Side B and 29-30 of Side A of CN1, respectively, to facilitate the transmission of lane 3 signals.

As shown in table 500, the pin 11 of Side A of CN3 is associated with the second reset signal PERST1#. Accordingly, in configuring the PCIe AIC adapter cable 130, the pin 11 of Side A of CN3 is connected to pin 32 of side A of CN1. Similarly, the pins 13-14 of Side A of CN3 can be connected to the pins 35-36 of Side A of CN3 to facilitate the transmission of the second pair of reference clock signals.

The remaining used pins in table 500 belong to the first group of signals. In configuring the PCIe AIC adapter cable 130, these used pins can be connected to the corresponding used pins of CN1 in table 300. For example, the pair of pins in table 500 and 300 having the same pin number can be connected.

While the PCIe AIC adapter cable disclosed herein is introduced in the context of SSD memory controller EVB testing, the application of the PCIe AIC adapter cable is not limited to the testing environment. For example, the PCIe AIC adapter cable can be applied to a storage system in a data center or other suitable scenarios. In place of the PCIe AIC 110 and computers 140 and 145, PCIe AICs and computers in real-world applications can be configured to form a working system based on the PCIe AIC adapter cable disclosed herein. Also, in place of the SSD memory system, other types of memory systems implemented in a PCIe AIC can also take advantage of the PCIe AIC adapter cable, such as a main memory, a cache memory, a backup memory, a redundant memory, and the like. The computers connected to the PCIe AIC via the PCIe AIC adapter cable can be a mobile phone, a laptop computer, a desktop computer, a server, a workstation, and the like.

Further, in addition to the storage system, the PCIe AIC adapter cable can also be used for other types of systems, such as graphic cards, sound cards, network adapter cards, and the like. Generally, for any system implemented in a PCIe AIC and employing PCIe as a transport for connecting a device to multiple hosts, the PCIe AIC adapter cable disclosed herein can be useful. In some particular cases, the adapter cable disclosed herein is combined with a communication protocol other than PCIe protocols. For example, a device implementing a protocol other than PCIe can be connected to a plurality of devices implementing the same protocol using the adapter cable disclosed herein.

In various implementations, the PCIe AIC adapter cable can have various variations. For example, for the PCIe receptacle connector (such as CN1 131) in a PCIe AIC adapter cable, any unused pins (e.g., pins 37 and 38 of Side B or pins 43 and 44 of side A) can be used for the transmission of one or more reset signals (PERST#) or one or more pairs of reference clock signals (REFCLK+/−). Those pins are then connected to suitable pins of the PCIe edge connector(s) (such as CN2 132 or CN3 133) in the PCIe AIC adapter cable. For example, the pins 39 and 40 of Side A can be used for transmitting the reference clock signals REFCLK1+/−. The pin 45 or 46 can be used for transmitting the reset signal PERST1#.

For another example, the connectors 131-133 may be physically different than the connectors as defined in the PCIe standard. For example, the unused pins may not be present in a connector. The size and/or shape of a connector may be different than what is specified in the PCIe standard.

For dual-port applications, there can be various combinations of the PCIe receptacle connector (denoted by CN-1) and the PCIe edge connectors (denoted by CN-2) regarding the link width. For example, in addition to the combination of one ×8 CN-1 to two ×4 CN-2 in the FIG. 1 example, other combinations can include:
one ×4 CN-1 to two ×1 CN-2 (2 lanes for dual-ports),
one ×16 CN-1 to two ×4 CN-2 (8 lanes for dual-ports).

In addition, the PCIe AIC adapter cable disclosed herein is not limited to the dual-port applications. For example, the PCIe AIC adapter cable can be used for applications of 3-port, 4-port, 5-port, 6-port, 7-port, 8-port, and the like. For example, for an N-port configuration where a device implemented in PCIe AIC is connected to N hosts, each host can be connected with a link width of at least one lane, and each host can be connected with at least one reset signal and one pair of reference clock signals. As far as the CN-1 has enough number of pins to support these signals, the PCIe AIC adapter cable can be suitably configured to support the N-port application.

For example, in an 8-port application, CN-1 of the PCIe AIC adapter cable can be a ×16 receptacle connector. CN-2 connectors of the PCIe AIC adapter cable can each be a ×1 or ×4 edge connector. Eight lanes are supported for connecting an 8-port device to 8 hosts. Each host is connected with a link of 1 lane. Eight sets of auxiliary signals can be connected from CN-1 to the eight CN-2 connectors, respectively. Each set of auxiliary signals can include a reset signal PERST# and a pair of differential reference clock signals REFCLK+/−.

Another possible variation of the PCIe AIC adapter cable disclosed herein can be that, in place of a connector (CN-1 or CN-2) given in the PCIe AIC adapter cable, another connector with a larger link width can be used to form a new PCIe AIC adapter cable. For example, for a PCIe AIC adapter cable with the signal definition in FIGS. 3A/3B/4/5, which uses a ×8 receptacle connector as CN-1, a ×16 receptacle connector can instead be used in place of the ×8 receptacle connector. Or, in the same example, for the ×4 edge connector used as CN-2, a ×8 edge connector can be used in place of the ×4 edge connector, assuming the receptacle connector of a host computer can be adjusted to receive the ×8 edge connector.

In a further example, multiple PCIe AIC adapter cables can be cascaded to match an application scenario. For example, a first PCIe AIC adapter cable, C1, includes a ×16 receptacle connector and two ×8 edge connectors for the transmission of 8 lanes in two links each of ×4 width. A second and third PCIe AIC adapter cable, C2 and C3, each include a ×8 receptacle connector and two ×4 edge connectors, similar to the configuration of the example of FIGS. 3A/3B/4/5. C1 can be connected to C2 and C3. For example, the two ×8 edge connectors of C1 can be connected to the two ×8 receptacle connectors of C2 and C3. For such an application, the receptacle connectors of C2 and C3 can each have a pinout of table 300 in FIGS. 3A-3B, where the auxiliary signals on pins 32, 35, and 35 can be provided from the ×16 receptacle connector of C1. Accordingly, the PCIe AIC adapter cable C1 can be configured to be able to transmit 4 sets of auxiliary signals, each set including a reset signal PERST# and a pair of differential reference clock signals REFCLK+/−.

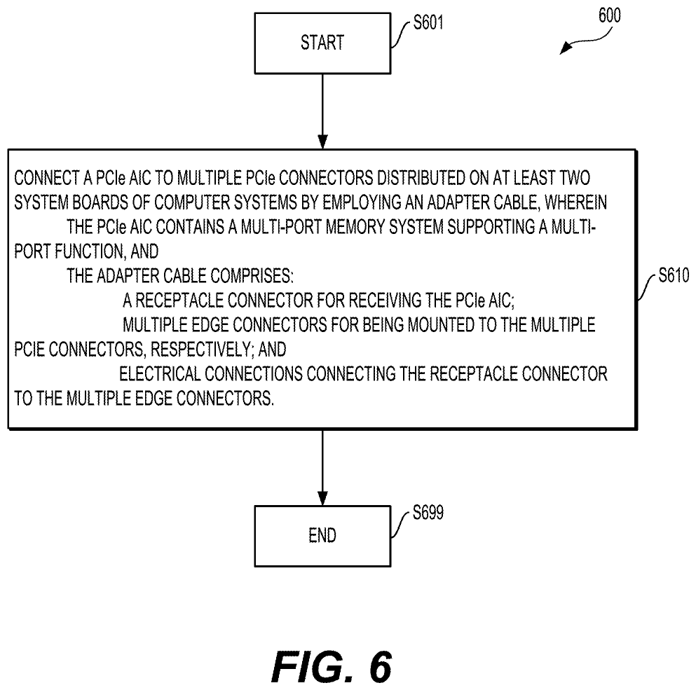

FIG. 6 shows a method 600 of setting up a storage system using the PCIe AIC adapter cable disclosed herein according to an embodiment of the disclosure. The method 600 includes one step labeled S610. The method 600 starts from S601.

At S610, by employing an adapter cable, a PCIe AIC can be connected to multiple PCIe connectors distributed on at least two system boards of computer systems. The PCIe AIC contains a multi-port memory system supporting a multi-port function. The multi-port function enables simultaneous access by the computer systems to a same namespace of the multi-port memory system. The adapter cable can include a receptacle connector for receiving the PCIe AIC. The receptacle connector includes contact pins as defined for a PCIe connector.

The adapter cable further includes multiple edge connectors for being mounted to the multiple PCIe connectors, respectively. Each edge connector can have edge pins as defined for a PCIe AIC. The adapter cable further includes electrical connections connecting the receptacle connector to the multiple edge connectors. Each electrical connection connects one of the contact pins to one of the edge pins. The method 600 terminates at S699.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. An adapter cable, comprising:
a receptacle connector including contact pins as defined for a peripheral component interconnect express (PCIe) connector;
edge connectors having edge pins as defined for a PCIe add-in card (AIC); and
connections connecting the receptacle connector to the edge connectors, each connection connecting one of the contact pins to one of the edge pins.

2. The adapter cable of claim 1, wherein the adapter cable is configured to connect a PCIe AIC to a plurality of PCIe connectors, the receptacle connector is configured to receive the PCIe AIC, and the edge connectors are configured to be mounted to the PCIe connectors.

3. The adapter cable of claim 2, wherein
first contact pins of the receptacle connector corresponding to at least one PCIe lane are connected to first edge pins of a first edge connector of the edge connector, via first connections of the connections,
second contact pins of the receptacle connector, different from the first contact pins, corresponding to another at least one PCIe lane are connected to second edge pins of a second edge connector of the edge connector,
for one of the edge connectors, a third contact pin of the receptacle connector is connected to a third edge pin of the respective edge connector, via one of the connections, the third edge pin corresponding to a reset signal as defined in PCIe, and
for one of the edge connectors, a pair of fourth contact pins of the receptacle connector are connected to a pair of fourth edge pins of the respective edge connector, via ones of the connections, the pair of fourth pins corresponding to a pair of reference clock signals as defined in PCIe.

4. The adapter cable of claim 3, wherein
the receptacle connector is a ×8 PCIe connector having 49 pins numbered from 1 to 49 on each of side A and side B, and one of the first edge connector and the second edge connector is a ×4 PCIe connector having 32 pins numbered from 1 to 32 on each of side A and side B;
the first contact pins are pins 14, 15, 19, and 20 of side B and pins 16, 17, 21, and 22 of side A of the receptacle connector that are connected to the first edge pins that are pins 14, 15, 19, and 20 of side B and pins 16, 17, 21, and 22 of side A of the first edge connector;
the second contact pins are pins 23, 24, 27, and 28 of side B and pins 25, 26, 29, and 30 of side A of the receptacle connector that are connected to the second edge pins that are pins 14, 15, 19, and 20 of side B and pins 16, 17, 21, and 22 of side A of the second edge connector;
for the first edge connector, pin 11 of side A of the receptacle connector corresponding to a first reset signal as defined in PCIe is connected to pin 11 of side A of the first edge connector;
for the second edge connector, pin 32 of side A of the receptacle connector corresponding to a reserved pin as defined in PCIe is connected to pin 11 of side A of the second edge connector;
for the first edge connector, the pins 13 and 14 of side A of the receptacle connector corresponding to a pair of reference clock signals as defined in PCIe are connected to the pins 13 and 14 of the first edge connector; and
for the second edge connector, the pins 35 and 36 of side A of the receptacle connector corresponding to a PCIe lane as defined in PCIe are connected to the pins 13 and 14 of the second edge connector.

5. The adapter cable of claim 3, wherein
the receptacle connector is a ×8 PCIe connector having 49 pins numbered from 1 to 49 on each of side A and side B, and one of the first edge connector and the second edge connector is a ×4 PCIe connector having 32 pins numbered from 1 to 32 on each of side A and side B; and
a reserved pin of side A of the receptacle connector as defined in PCIe is connected to pin 11 of side A of the second edge connector corresponding to a reset signal as defined in PCIe.

6. The adapter cable of claim 3, wherein
the receptacle connector is a ×8 PCIe connector having 49 pins numbered from 1 to 49 on each of side A and side B, and one of the first edge connector and the second edge connector is a ×4 PCIe connector having 32 pins numbered from 1 to 32 on each of side A and side B; and
a pin of side A of the receptacle connector corresponding to a PCIe lane as defined in PCIe is connected to pin 11 of side A of the second edge connector corresponding to a reset signal as defined in PCIe.

7. The adapter cable of claim 3, wherein
the receptacle connector is a ×8 PCIe connector having 49 pins numbered from 1 to 49 on each of side A and side B, and one of the first edge connector and the second edge connector is a ×4 PCIe connector having 32 pins numbered from 1 to 32 on each of side A and side B; and
two contact pins of the receptacle connector corresponding to signals of one or more PCIe lanes are connected to the pins 13 and 14 of the second edge connector corresponding to a pair of clock reference signals as defined in PCIe.

8. The adapter cable of claim 3, wherein a number of the contact pins in the receptacle connector is less than a number of contact pins defined in the PCIe connector.

9. The adapter cable of claim 3, wherein a number of the edge pins in the respective edge connector is less than a number of edge pins defined in the respective PCIe AIC.

10. The adapter cable of claim 3, wherein the receptacle connector is one of a ×4 PCIe connector, a ×8 PCIe connector, and a ×16 PCIe connector, and
one of the edge connectors is one of a ×1 PCIe connector, a ×4 PCIe connector, a ×8 PCIe connector, and a ×16 PCIe connector.

11. The adapter cable of claim 3, wherein a total number of the pins of one of the edge connectors is smaller than a total number of the pins of the receptacle connector.

12. The adapter cable of claim 3, wherein a number of the edge connectors are one of 2, 4, and 8.

13. A storage system, comprising:
a peripheral component interconnect express (PCIe) add-in card (AIC) containing a multi-port memory system supporting a multi-port function that enables simultaneous access by computer systems to a same namespace of the multi-port memory system;
the computer systems containing PCIe connectors, respectively; and
an adapter cable connecting the PCIe AIC to the PCIe connectors of the computer systems, the adapter cable comprising:
a receptacle connector including contact pins as defined for a PCIe connector;
edge connectors having edge pins as defined for a PCIe AIC; and
connections connecting the receptacle connector to the edge connectors, each connection connecting one of the contact pins to one of the edge pins.

14. The storage system of claim 13, wherein the multi-port memory system is a PCIe-based solid-state drive (SSD) containing a memory controller implementing a non-volatile memory express (NVMe) dual-port function.

15. The storage system of claim 13, wherein first contact pins of the receptacle connector corresponding to at least one PCIe lane are connected to first edge pins of a first edge connector of the edge connectors, via first connections of the connections,
second contact pins of the receptacle connector, different from the first contact pins, corresponding to another at least one PCIe lane are connected to second edge pins of a second edge connector of the edge connectors,
for one of the edge connectors, a third contact pin of the receptacle connector is connected to a third edge pin of the respective edge connector, via one of the connections, the third edge pin corresponding to a reset signal as defined in PCIe, and
for one of the edge connectors, a pair of fourth contact pins of the receptacle connector are connected to a pair of fourth edge pins of the respective edge connector,
via ones of the connections, the pair of fourth pins corresponding to a pair of reference clock signals as defined in PCIe.

16. The storage system of claim 15, wherein
the receptacle connector is a ×8 PCIe connector having 49 pins numbered from 1 to 49 on each of side A and side B, and one of the first edge connector and the second edge connector is a ×4 PCIe connector having 32 pins numbered from 1 to 32 on each of side A and side B;
the first contact pins are pins 14, 15, 19, and 20 of side B and pins 16, 17, 21, and 22 of side A of the receptacle connector that are connected to the first edge pins that are pins 14, 15, 19, and 20 of side B and pins 16, 17, 21, and 22 of side A of the first edge connector;
the second contact pins are pins 23, 24, 27, and 28 of side B and pins 25, 26, 29, and 30 of side A of the receptacle connector that are connected to the second edge pins that are pins 14, 15, 19, and 20 of side B and pins 16, 17, 21, and 22 of side A of the second edge connector;
for the first edge connector, pin 11 of side A of the receptacle connector corresponding to a first reset signal as defined in PCIe is connected to pin 11 of side A of the first edge connector;
for the second edge connector, pin 32 of side A of the receptacle connector corresponding to a reserved pin as defined in PCIe is connected to pin 11 of side A of the second edge connector;
for the first edge connector, the pins 13 and 14 of side A of the receptacle connector corresponding to a pair of reference clock signals as defined in PCIe are connected to the pins 13 and 14 of the first edge connector; and
for the second edge connector, the pins 35 and 36 of side A of the receptacle connector corresponding to a PCIe lane as defined in PCIe are connected to the pins 13 and 14 of the second edge connector.

17. The storage system of claim 15, wherein
the receptacle connector is a ×8 PCIe connector having 49 pins numbered from 1 to 49 on each of side A and side B, and one of the first edge connector and the second edge connector is a ×4 PCIe connector having 32 pins numbered from 1 to 32 on each of side A and side B; and
a reserved pin of side A of the receptacle connector as defined in PCIe is connected to pin 11 of side A of the second edge connector corresponding to a reset signal as defined in PCIe.

18. A method of setting up a storage system, comprising:
connecting a peripheral component interconnect express (PCIe) add-in card (AIC) to PCIe connectors distributed on at least two system boards of computer systems by employing an adapter cable, wherein
the PCIe AIC contains a multi-port memory system supporting a multi-port function that enables simultaneous access by the computer systems to a same namespace of the multi-port memory system, and
the adapter cable comprises:
a receptacle connector for receiving the PCIe AIC, the receptacle connector including contact pins as defined for a PCIe connector;
edge connectors for being mounted to the PCIe connectors, respectively, one of the edge connectors having edge pins as defined for a PCIe AIC; and
connections connecting the receptacle connector to the edge connectors, each connection connecting one of the contact pins to one of the edge pins.

19. The method of claim 18, wherein the multi-port memory system is a PCIe-based solid-state drive (SSD) containing a memory controller implementing non-volatile memory express (NVMe) dual-port function.

20. The method of claim 18, wherein
first contact pins of the receptacle connector corresponding to at least one PCIe lane are connected to first edge pins of a first edge connector of the edge connectors, via first connections of the connections,
second contact pins of the receptacle connector, different from the first contact pins, corresponding to another at least one PCIe lane are connected to second edge pins of a second edge connector of the edge connectors,
for one of the edge connectors, a third contact pin of the receptacle connector is connected to a third edge pin of the respective edge connector, via one of the connections, the third edge pin corresponding to a reset signal as defined in PCIe, and
for one of the edge connectors, a pair of fourth contact pins of the receptacle connector are connected to a pair of fourth edge pins of the respective edge connector, via ones of the connections, the pair of fourth pins corresponding to a pair of reference clock signals as defined in PCIe.
